(19) United States
(12) Patent Application Publication
(10) Pub. No.: US 2022/0332051 A1
(43) Pub. Date: Oct. 20, 2022

(54) Bespoke Grip for Handheld Apparatuses

(71) Applicant: Christopher Ryan, Wheaton, IL (US)

(72) Inventor: Christopher Ryan, Wheaton, IL (US)

(21) Appl. No.: 17/710,561

(22) Filed: Mar. 31, 2022

Related U.S. Application Data
(60) Provisional application No. 63/168,599, filed on Mar. 31, 2021.

(51) Int. Cl. B29C 64/386; B33Y 50/00; B29C 33/38

(52) U.S. Cl. CPC B29C 64/386; B33Y 50/00; B29C 33/3857; B29L 2031/463

(57) ABSTRACT

A method for producing a bespoke grip accessory for a handheld apparatus. In one embodiment, the method comprises determining a person who will be gripping the handheld apparatus, encasing a replica of a gripping surface of the handheld apparatus in a conformable mold, obtaining an imprint of a grip profile of the person in the conformable mold encasing the replica gripping surface, hardening the mold comprising the imprint of the grip profile into a hardened mold, scanning the hardened mold to obtain a data file comprising a three-dimensional representation of the grip profile imprinted in the hardened mold, converting the data file to a format suitable for fabricating a grip accessory fitting both the gripping surface and the imprint of the grip profile, and fabricating a bespoke grip accessory based on the converted data file, wherein the fabricating comprises a process further comprising additive manufacturing.

### CROSS-REFERENCE TO RELATED APPLICATIONS

This application claims priority to U.S. Provisional Patent Application Ser. No. 63/168,599 filed Mar. 31, 2021, the entire contents of which are incorporated herein by reference thereto.

### STATEMENT REGARDING FEDERALLY SPONSORED RESEARCH OR DEVELOPMENT

Not applicable.

### BACKGROUND OF THE INVENTION

### Field of the Invention

The present invention is directed to a method of producing accessories for handheld apparatuses, and more specifically to fabrication of bespoke grip accessories wherein the fabrication may comprise additive manufacturing processes.

### Background of the Invention

Throughout human history, handheld implements have been utilized in a wide ranging variety of endeavors, examples of which may include cultivating land, preparing food, performing labor, maintaining equipment, undertaking casual, pastime, or competitive activities, defending persons, property, or community, or delivering professional services such as medical or dental services. Handheld implements intended for application within a particular scope such as these or other endeavors typically exhibit designs which feature grips having similar shapes, sizes, and configurations. For example, handheld tools such as drills, athletic equipment such as golf clubs, or firearms such as pistols or rifles, each comprise grips which are substantially similar within their product family. Moreso, when a particular handheld apparatus is manufactured in volume for use by a large segment of a population, its design may favor a “one size fits all” approach, in turn maximizing the financial benefit of exploiting economies of scale in serving that market. Typically, at best its design may be segmented into categories intended to cater their fit to tiers of a sub-population of users, for example offering grip sizes which might be tailored for small, medium, or large hands.

In contrast, as individuals, people are unique, and the statement “no two are alike” may be widely viewed as conveying a universal truth. Likewise, a person's hands and the profile with which their grip may be applied in holding a handheld implement may be equally unique, reflecting such aspects as hand size, hand orientation, finger alignment, relative muscle tensions, distribution of gripping pressure, contacted surface area, and/or preferences such as balance or tactile sensation. In practice, a combination of these aspects may be conveyed to a person learning to use a handheld apparatus through generic phrases such as “a firm grip”, “a light touch”, “a heavy hand”, or similar. Further, as a person ages their natural or preferred grip profile when using a particular handheld apparatus may change over time or require adaptation.

Therefore, it naturally follows that a bespoke grip, fitted to match a handheld implement to a person's natural or preferred grip profile, may provide advantages in the use of that implement, or may result in improvements in its use that may be gauged in terms of efficiency, accuracy, or similar measures. Custom grips may be known in the art and available within limited segments of a broad market, but their method of production may be cost-prohibitive, application-specific, require excessive time to produce, result in excessive weight added to the handheld apparatus, or they may be difficult to change over time as a person's grip profile evolves. Consequently, there is a need for a method of producing a bespoke grip accessory for a handheld apparatus which provides the advantages of a customized grip while improving upon these limitations of prevailing solutions.

### BRIEF SUMMARY OF SOME OF THE PREFERRED EMBODIMENTS

These and other needs in the art are addressed in one embodiment by a method for producing a bespoke grip accessory for a handheld apparatus which comprises an additive manufacturing process. The method begins by first determining the handheld apparatus and a person who will be gripping the handheld apparatus.

In one embodiment, the method proceeds with encasing a replica of a gripping surface of the handheld apparatus in a conformable mold, obtaining an imprint of a grip profile of the person in the conformable mold, hardening the mold comprising the imprint into a hardened mold, and scanning the hardened mold to obtain a data file comprising a three-dimensional representation of the hardened mold imprinted with the person's grip profile. In an alternate embodiment, the method proceeds with measuring the person's grip profile via a specialized glove capable of gauging one or more pressure measurements that may be recorded in a data file comprising a three-dimensional representation of the person's grip profile.

The method then proceeds with converting the data file to a format suitable for fabricating the grip accessory fitting both the replica gripping surface and the person's grip profile, and finally fabricating a bespoke grip accessory based on the converted data file, wherein the fabricating comprises an additive manufacturing process and a finishing process.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of a method for producing a bespoke grip accessory for a handheld apparatus;

FIG. 2 illustrates an embodiment of a standard mil-spec pistol grip;

FIG. 3A illustrates a first side profile of an embodiment of a bespoke grip accessory formed in accordance with the methods described herein for replacing a standard mil-spec pistol grip;

FIG. 3B illustrates a second side profile of an embodiment of a bespoke grip accessory formed in accordance with the methods described herein for replacing a standard mil-spec pistol grip; and

FIG. 3C illustrates a front profile of an embodiment of a bespoke grip accessory formed in accordance with the methods described herein for replacing a standard mil-spec pistol grip.

### DETAILED DESCRIPTION OF THE PREFERRED EMBODIMENTS

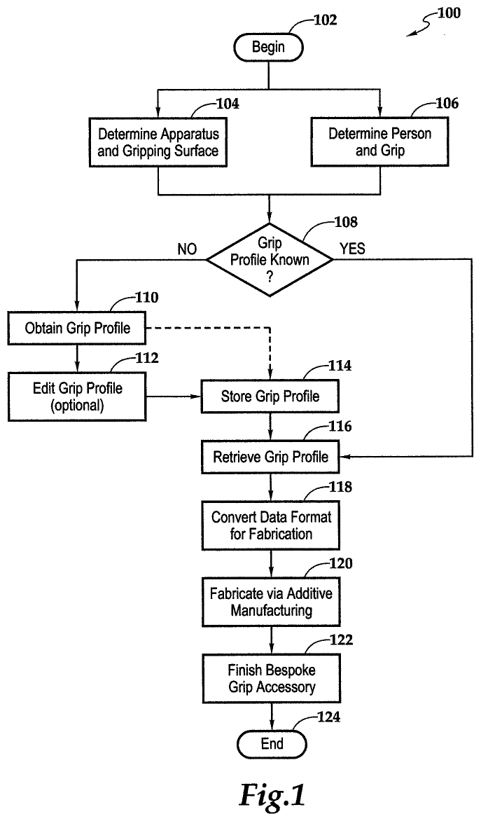

FIG. 1 illustrates an embodiment of method 100 for producing a bespoke grip accessory for a handheld apparatus. The method may begin at step 102 and proceeds by determining, selecting, or identifying a handheld apparatus or implement onto which the bespoke grip assembly is to be attached at method step 104, and determining, selecting, or identifying a person to whom the bespoke grip accessory is to be fitted at method step 106. In embodiments of method 100, method steps 104 and 106 may be performed simultaneously, in parallel, or in any sequential order. In embodiments, the handheld apparatus or implement may be known or unknown, and may further comprise one or more gripping surfaces for which measurement information may be known or unknown. For example, the one or more gripping surfaces may correspond to one or more surfaces which may be gripped by a person by a first hand, a second hand, a left hand, a right hand, two hands simultaneously, two hands in a predetermined left/right configuration, two hands in an ambidextrous configuration, or combinations thereof. Similarly, the person to whom the bespoke grip assembly is to be fitted may be known or unknown, wherein information regarding a grip profile of the known person may be known or unknown. For example, the grip profile may correspond to a left hand of the person, a right hand of the person, a relaxed, loose, open, or idle grip of the person, a tightened, strong, closed, or activated grip of the person, or combinations thereof.

In embodiments, the measurement information regarding each of the one or more gripping surfaces may comprise general dimensions, detailed measurements, or sufficient other information to be able to produce a three-dimensional rendering of the gripping surface, for example information obtained from a three-dimensional scan. Such measurement information may be stored in either a physical medium, such as a registry, or a computer-readable storage medium, such as a database, or combinations thereof.

In embodiments, the information regarding a person's grip profile may comprise general information such as hand size or various measurements relating to one or both of the person's hands, or information regarding natural or preferred hand orientation, finger alignment, relative muscle tensions, distribution of gripping pressure, contacted surface area, and/or preferences such as balance or tactile sensation. In embodiments, information regarding the person's grip profile may comprise sufficient other information to be able to produce a three-dimensional rendering of the person's grip profile, and may further comprise such information in relation to one or more gripping surfaces of one or more handheld apparatuses or implements. Such information regarding a person's grip profile may be stored in either a physical medium, such as a registry, or a computer-readable storage medium, such as a database, or combinations thereof.

Upon selection or identification of the handheld apparatus or implement, and the person to whom the bespoke grip accessory is to be fitted, the method proceeds through step 108 based on whether information regarding a grip profile of the person may be known or unknown relative to the one or more gripping surfaces of the selected or identified handheld apparatus or implement. Where information regarding the handheld apparatus or implement, its one or more gripping surfaces, or the grip profile of the person relative to the one or more gripping surfaces of the selected or identified handheld apparatus or implement is known, the method may proceed to step 116 wherein such information may be retrieved from either a physical medium, such as a registry, or a virtual medium, such as a database, or combinations thereof.

In embodiments where information regarding the person's grip profile may be unknown, the method may proceed to step 110 which comprises measuring the grip profile of the person relative to the one or more gripping surfaces of the handheld apparatus or implement.

In a first embodiment of method step 110, the grip profile may be measured by first encasing the one or more gripping surfaces, or one or more replicas thereof, of the handheld apparatus or implement in a conformable mold. Replicas of a gripping surface may be formed from any material and in such a manner as to provide a reproduction of one or more surface profiles of the gripping surface which is replicated. In embodiments, the replica may comprise a skeletonized replication of the gripping surface. The conformable mold may comprise a known substance or it may be formed from a known material, for example a silicone-based mold, or it may comprise or be formed from a proprietary material, for example a proprietary composite, blend, or mixture. Next, the person may be directed to grip the conformable mold in a preferred manner and with sufficient force to produce an imprint of the person's grip in the mold, wherein the preferred manner may comprise achieving a preferred level of comfort, perceived or preferred ability to balance or control the handheld apparatus or implement, or ability to apply a preferred or required amount of force to the gripping surface, wherein such preferred aspects may be based upon the person's preference or the preference of another person or third party.

Proceeding in the embodiment, upon obtaining an imprint of the grip profile in the conformable mold, the conformable mold may be allowed to harden into a hardened mold. Once the conformable mold is hardened, information regarding the grip profile may be obtained from the hardened mold and recorded in a data file, wherein such information may be sufficient to be able to produce a three-dimensional rendering of the person's grip profile, and wherein such information may further comprise additional information regarding the person's grip profile in relation to the one or more gripping surfaces encased by the mold. In embodiments, such information may be obtained by three-dimensional scanning of the hardened mold, wherein the three-dimensional scanning may further comprise obtaining a plurality of two-dimensional measurements, or “slices,” which together may provide the ability to render a three-dimensional representation of the person's grip profile, or similar scanning techniques. Once such information has been obtained, the data file may be stored in a suitable computer-readable storage medium for subsequent retrieval, such as a database, and the hardened mold may be discarded, re-used, or marked with an identifier and stored for subsequent retrieval.

In a second embodiment of method step 110, the grip profile may be measured by means of a specialized glove capable of measuring aspects of the person's grip profile. In such embodiments, the person may be directed to wear the specialized glove and to subsequently grip the one or more gripping surfaces of the handheld apparatus or implement in a preferred manner, wherein the preferred manner may comprise achieving a preferred level of comfort, perceived or preferred ability to balance or control the handheld apparatus or implement, or ability to apply a preferred or required amount of force to the gripping surface, wherein such preferred aspects may be based upon the person's preference or the preference of another person or third party. The measured aspects recorded by the specialized glove may comprise one or more characteristics of the person's grip profile, for example hand orientation, one or more finger alignments or orientations, or pressure measurements. In embodiments, the one or more pressure measurements may be taken at points strategically located about the gripping surface, such as one or more contact points determined to provide a person with a preferred ability to balance or control the handheld apparatus or implement, or apply a required amount of force to the gripping surface, or similar strategic considerations. Information regarding the one or more characteristics of the person's grip profile or pressure measurements may be recorded in a data file, wherein such information may be sufficient to be able to produce a three-dimensional rendering of the person's grip profile, and wherein such information may further comprise additional information regarding the person's grip profile in relation to the one or more gripping surfaces. Once such information has been obtained, the data file may be stored in a suitable computer-readable storage medium for subsequent retrieval, such as a database.

At method step 112, the data files comprising the grip profile obtained through one of the embodiments of method step 110 may optionally be edited or refined. In embodiments, the editing may include appending the data files to include one or more features or aspects of the grip profile which may be desired by the person for whom it is being fitted, for example adding or adjusting a surface texture or general aspects regarding size, thickness, or other dimensional characteristics which may contribute to hand-feel or weight. In further embodiments of method step 112, the editing may be undertaken by, in coordination with, or based upon information received from, one or more persons who may be knowledgeable about the handheld apparatus or implement, one or more persons who may be knowledgeable with one or more preferred or desirable aspects of handling the apparatus or implement, for example a level of comfort, balance, control, or proficiency, or one or more persons who may be knowledgeable about a preferred or desirable amount or distribution of gripping force to be applied to one or more gripping surfaces of the apparatus or implement. At method step 114, the one or more data files comprising the original grip profile and/or the edited or refined data files may be stored for subsequent retrieval.

Once the data files comprising information regarding the one or more gripping surfaces and/or the person's grip profile have been obtained, through either of the embodiments of method step 110 previously described or through retrieval from a virtual storage medium at method step 116, the method may continue to step 118 wherein one or more data files comprising the person's grip profile may be converted to a format suitable for fabricating a bespoke grip accessory fitting the gripping surface of the selected or identified handheld apparatus or implement, the grip profile of the selected or identified person, or combinations thereof. The conversion may comprise converting the one or more data files to a format suitable for one or more additive manufacturing processes. In embodiments, such additive manufacturing processes may comprise, for example, material extrusion, vat polymerization, material jetting, binder jetting, powder bed fusion, sheet lamination, or similar additive manufacturing processes which may be specified by the ISO/ASTM 52900:2015 or similar specifications.

Following conversion of the one or more data files to a format suitable for one or more additive manufacturing processes at method step 118, one or more characteristics of the bespoke grip accessory to be customized may be obtained from the person for whom it is to be fitted or another person, for example if the bespoke grip accessory may comprise a gift or if a plurality of bespoke grip accessories may require a uniform set of characteristics for an organization. Such characteristics may comprise aesthetic qualities such as color, color pattern, or an embedded pattern or logo, or such characteristics may comprise tactile qualities such as material type, texture, or roughness, each of which may be specified to be uniformly applied in fabricating the bespoke grip accessory, or may be specified to be applied to one or more designated areas or volumes comprising the bespoke grip accessory.

The method may then proceed to step 120, wherein the bespoke grip accessory may be fabricated based on the one or more converted data files and the one or more characteristics to be customized which may have been obtained, wherein the fabricating may comprise a process further comprising additive manufacturing, for example material extrusion, vat polymerization, material jetting, binder jetting, powder bed fusion, sheet lamination, or similar additive manufacturing processes which may be specified by the ISO/ASTM 52900:2015 or similar specifications. In embodiments, the fabricating may comprise materials, compounds, or filaments known in the art, for example the fabricating may comprise a metal, or a wood-based or polymer-based filament such as Acetonitrile Butadiene Styrene (ABS).

Once the bespoke grip accessory has been fabricated, the method may continue to step 122 wherein the bespoke grip accessory may be inspected for deviations from expected or specified quality measures, and may be refined into a finished product, for example by sanding or polishing. Finally, additional items or materials may be added to the finished bespoke grip accessory, such as decals, an embedded object, a surface protectant, or other such items or materials. Upon completion of any desired refining or finishing procedures, the method may end at step 124.

In this disclosure, certain descriptions may have been made of method steps, processes, or procedures comprising obtaining, storing, retrieving, or converting information, data, or data files. Such method steps, processes, or procedures may be performed on one or more computational platforms which may comprise one or more processing, memory, storage, communication, or other components similar to those described in U.S. Patent Publication No. 2013/0326497 and/or U.S. Pat. No. 9,764,348, the entire contents of which are hereby incorporated herein by reference thereto. As utilized herein, a computer readable storage medium may comprise volatile memory, non-volatile memory, local storage, cloud storage, client or server storage, one or more files, one or more databases, or combinations thereof.

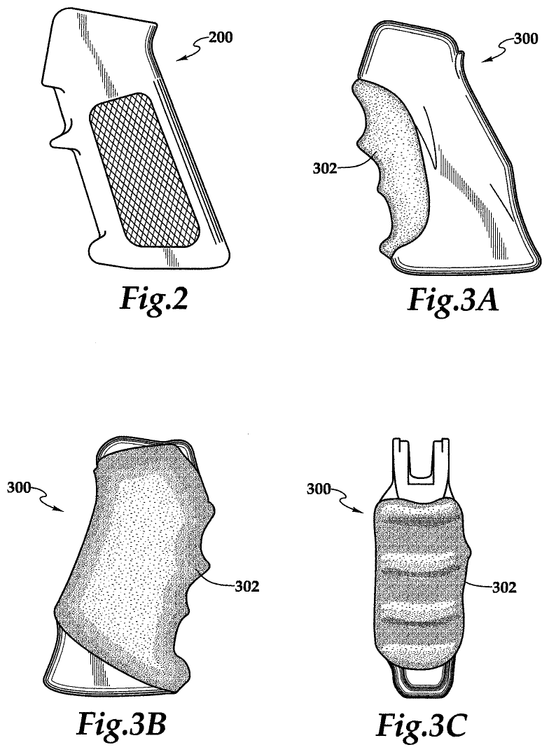

FIG. 2 illustrates an embodiment of a stock grip 200 for an AR-15 rifle, while FIGS. 3A through 3C illustrate an embodiment of a bespoke grip accessory 300 formed in accordance with the methods described herein to include an embodiment of a grip profile 302. In embodiments, a bespoke grip accessory may serve as a replacement for a standard or stock grip of a handheld apparatus or implement, or may be formed and configured in a design intended to augment such a standard grip, for example by disposing the bespoke grip accessory on or about one or more gripping surfaces of a standard grip of a handheld apparatus or implement. In embodiments, the method for producing a bespoke grip accessory for a handheld apparatus or implement as described herein may be utilized across a wide variety of applications, for example including but not limited to firearms, sports accessories, culinary tools, vehicle controls, landscaping equipment, medical equipment or hand tools. Examples of firearms may include pistols, rifles, shotguns, bows, crossbows, spear guns, or similar handheld weapons. Examples of sports accessories may include golf clubs, tennis rackets, ping pong handles, hockey sticks, baseball gloves or similar accessories. Examples of vehicle controls may include gear knobs, throttle controls disposed on airplanes or helicopters, a steering wheel or steering control, a handle grip disposed on a motorcycle, steering wheels, yokes, or similar controls. To further illustrate various illustrative embodiments of the present invention, the following examples are provided.

### Example 1

A person who is an avid hunter may have received as a gift an AR-15 rifle, and the AR-15 may have been manufactured having a standard mil-spec (military specification) pistol grip similar to that illustrated as stock grip 200 in FIG. 2. The person may desire a bespoke grip accessory in order to improve her handling of the rifle, or as an accessory which may help improve her firing accuracy at long ranges, and she may prefer the accessory in black to match the stock color of her rifle. Accordingly, the person decides to have a bespoke grip accessory fabricated for her rifle in accordance with the methods disclosed herein. Upon arriving at a retail outlet where bespoke grip accessories may be purchased, she provides details regarding her AR-15 or may bring with her the mil-spec pistol grip from her rifle. A sales representative may ask a technician to retrieve a replica of her mil-spec grip and confirm with her that it matches that of her rifle. A technician may then encase the surface of the replica grip in a conformable mold and attach it to a shop demo of a matching AR-15, which the hunter is then directed to grip in a manner which provides her a preferred balance of the weapon and level of comfort when aiming. An imprint of her grip may then be captured by the conformable mold. The mold may be allowed to harden, for example over a period of 10 minutes, and the technician may then take the hardened mold to the back of the retail outlet to be 3D scanned. Once scanned, the resulting data file may be stored on the shop's computer and subsequently converted to a format appropriate for use in a filament-based 3D printer. The technician may then load the 3D printer with a black ABS plastic filament and proceed to 3D print her bespoke grip accessory similar to that illustrated as bespoke grip 300 in FIGS. 3A through 3C. Upon completion of the printing process, the technician may then inspect and lightly sand the accessory for delivery to the customer.

At some later date, the hunter may choose to use her AR-15 while hunting at which time she may have chosen to wrap her AR-15 in a camouflage-patterned “skin.” Her hunting trip may be scheduled to begin the following day, and that morning she decides that her bespoke grip accessory should match the camouflage finish, so she places an order for the replacement accessory with the retail outlet. Upon receiving her order, the technician at the retail outlet promptly 3D prints the bespoke grip accessory using the data files on-hand specific to her grip profile, this time utilizing various colored filaments combined to print in a camouflage pattern. The technician couriers the camouflage bespoke grip accessory to the hunter, who receives the item that evening and is ready for her hunting trip the following day.

### Example 2

A golfer just purchased a new set of golf clubs. The golfer is happy with the face of the club and the shaft but would like to change the grip to something more comfortable and at the same time be able to help improve his golf game. The golfer may visit a retail store at which a bespoke grip may be manufactured for him, and he may explain to a retail associate what he would like to accomplish, for example, reduce slice with his driver, increase club feel with his irons, and increase his accuracy with his putter. The retail associate may then offer to the golfer a few options of diameter for each of his different clubs, and the golfer may choose to first try a bespoke grip for his drivers. Upon selecting which diameter(s) of grip fits the golfer's drivers, the associate may then refer the golfer to a golf pro and a technician to consult about what recommendations may be best to enhance the golfer's game. After receiving proper instruction from the golf pro, the technician may then fit a conformable mold over the shaft of one of the drivers, and then instruct the golfer to grip the driver either how he is comfortable or how the golf pro has instructed him to, thus imprinting the golfer's grip profile in the mold. The mold may then be allowed to harden, and the technician may then take the hardened mold to the back of the retail store to be 3D scanned. Once scanned, the resulting data file may be stored on a computer at the retail shop and subsequently converted to a format suitable for use in a filament-based 3D printer. The technician may then load the 3D printer with a black ABS plastic filament and proceed to 3D print the bespoke grip accessory for one of the drivers. Upon completion of the printing process, the technician may then inspect and lightly sand the accessory for delivery to the golfer. The golfer may repeat this process for each of his remaining drivers.

At a later date the golfer may have noticed an improvement in his driving while his irons are the same as before. He may then desire a set of bespoke grips for his irons, similar to those he had made for his drivers. The golfer may then place an order with the retail store for a set of bespoke grips for his irons, which the retail store may produce based on the scan of the golfer's grip profile which they have on-record, and the retail store may send the bespoke grip for the irons to the golfer.

### Example 3

An experienced chef has just purchased a new chef knife, selecting the knife because of its exquisite blade. After using the knife just a few times, the chef may come to the conclusion that the handle doesn't work well with the shape of her hand. For example, either the handle was too big or too small, or the chef thought it wouldn't be safe to continue using the knife during her highly stressful workday without changing its grip. The chef may call a trained technician to fit her knife with a bespoke grip using the method described herein. After a brief consultation over the phone about the size of the current handle and what improvements in the grip the chef would prefer, the technician may visit her restaurant with a portable scanner, a set of predetermined conformable molds and a mobile filament-based 3D printer with a selection of filaments. Upon arriving, the technician may clarify which general aspects of gripping the knife may best fit the chef's needs, and accordingly may place a conformable mold over the knife's current handle. The chef may then grip the mold with her hand in the position most comfortable for her, creating an impression of her grip profile into the mold, and the mold may be allowed to harden. During this time, the chef may select a color of filament or a design to be printed on the new bespoke grip. The technician may then scan the mold at the restaurant, and once scanned, the resulting data file may be stored on the technician's computer and subsequently converted to a format appropriate for use in the filament-based 3D printer. The technician may then load the 3D printer with an ABS plastic filament corresponding to the chefs selected color or pattern, and proceed to 3D print her bespoke grip accessory. Upon completion of the printing process, the technician may then inspect and lightly sand the accessory and help the chef fit it to her knife.

After some time, the chef may acquire a few more culinary tools, each of which present the chef with similar gripping problems as her chef knife. After another qualifying consultation with the technician, the chef may order additional bespoke grips for each of the remaining tools of her culinary toolkit, and may specify that each has its own unique design or branding corresponding with the chefs restaurant.

### Example 4

A highly experienced helicopter pilot with countless hours of training and flight time may have just purchased a used helicopter for himself and his family to enjoy and may wish to change the grip of his cyclic, throttle, and collective. After reviewing aftermarket options, he may prefer to have a grip that best fits his hand, will last for a long time, and may be used interchangeably between different aircraft. He may reach out to a retailer of bespoke grip authorized to use the methods described herein. After a few qualifying conversations with a technician about the needs of the pilot the technician may meet with the pilot, and provide a variety of conformable molds of varying sizes that may best fit the pilot's hands and the helicopter's controls. After selecting an appropriate mold size and forming the mold to encase the craft's control handles, the technician may instruct the pilot to apply direct and firm pressure to the mold to leave an imprint of the pilot's grip profile in the mold. The mold may be allowed to harden, and during this time the pilot may select a color of the filament or a design to be printed in the bespoke grip. The technician may scan the mold on-site or at a central location, and once scanned, the resulting data file may be stored on the technician's computer and subsequently converted to a format appropriate for use in a 3D printer. The technician may then proceed to 3D print the bespoke grips, and may then inspect and lightly sand the grip accessory for delivery to the customer.

### Example 5

A trade worker using a pneumatic nailer to lay roofing on a client's house may notice that during the middle of summer his grip on the nailer may become uncontrolled due to his perspiration. He may have noticed this issue on several occasions, recognizing that it is an unsafe practice to not have a firm, solid grip on his tool—which might result in injury to himself or those around him by misfiring a nail. The trade worker may recognize that a bespoke grip accessory may allow him to work more safely and also allow him to be more accurate and faster in completing his task. Accordingly, he may decide to have a bespoke grip accessory fabricated for his pneumatic nailer in accordance with the methods disclosed herein. Upon arriving at a retail outlet where bespoke grip accessories may be purchased, the trade worker may provide details regarding his pneumatic nailer, and may also bring it with him. A technician at the retail outlet may then provide a conformable mold to be wrapped around the grip of the nailer and instruct the trade worker to grip the mold as he would normally if using the pneumatic nailer, thus leaving an imprint of his grip profile in the mold. The technician may then remove the mold from the nailer and set it aside to harden. The technician may then take the hardened mold to the back of the retail outlet to be 3D scanned, and once scanned the resulting data file may be stored on the retail outlet's computer and subsequently converted to a format appropriate for use in a filament-based 3D printer. The technician may then load the 3D printer with filament selected by the trade worker, and proceed to 3D print a bespoke grip accessory for the pneumatic nailer. Upon completion of the printing process, the technician may inspect and touch-up the accessory prior to providing it to the customer.

At a later time the worker may have additional tools for which he desires similar levels of safety and precision which a bespoke grip may provide. The technician at the retail outlet, having the saved profile of the worker's grip profile, may then able to manipulate the stored data file corresponding to the trade worker's grip profile with the use of slicing software, such that the technician may provide the trade worker with bespoke grip accessories based on a same or similar grip profile for use with his other tools of his trade.

Although the present invention and its advantages have been described in detail, it should be understood that various changes, substitutions and alterations may be made herein without departing from the spirit and scope of the invention as defined by the appended claims.

What is claimed is:

1. A method for producing a bespoke grip accessory for a handheld apparatus, the method comprising:
a. identifying the handheld apparatus;
b. determining a person who will be gripping the handheld apparatus;
c. encasing a replica of a gripping surface of the handheld apparatus in a conformable mold;
d. obtaining an imprint of a grip profile of the person in the conformable mold encasing the replica gripping surface;
e. hardening the mold comprising the imprint of the grip profile into a hardened mold;
f. scanning the hardened mold to obtain a data file comprising a three-dimensional representation of the grip profile imprinted in the hardened mold;
g. converting the data file to a converted data file having a format suitable for fabricating a grip accessory fitting both the gripping surface and the imprint of the grip profile; and
h. fabricating a bespoke grip accessory based on the converted data file, wherein the fabricating comprises a process further comprising additive manufacturing.

2. The method of claim 1, wherein the bespoke grip accessory is formed as a replacement for a stock grip of the handheld apparatus.

3. The method of claim 1, wherein the bespoke grip accessory is formed to augment a stock grip of the handheld apparatus.

4. The method of claim 1, wherein the handheld apparatus comprises a firearm.

5. The method of claim 4, wherein the handheld apparatus comprises a pistol, a rifle, a shotgun, a bow, a crossbow, or a spear gun.

6. The method of claim 1, wherein the handheld apparatus comprises a sport accessory.

7. The method of claim 6, wherein the handheld apparatus comprises a golf club, a tennis racket, a hockey stick, a ping pong handle, or a baseball glove.

8. The method of claim 1, wherein the handheld apparatus comprises a culinary tool.

9. The method of claim 8, wherein the handheld apparatus comprises a chef's knife.

10. The method of claim 1, wherein the handheld apparatus comprises a vehicle control.

11. The method of claim 10, wherein the handheld apparatus comprises a gear knob, a throttle control, a steering wheel, or a handle grip.

12. The method of claim 1, wherein the handheld apparatus comprises landscaping equipment.

13. The method of claim 1, wherein the handheld apparatus comprises medical equipment.

14. The method of claim 1, wherein the handheld apparatus comprises a hand tool.

15. The method of claim 14, wherein the handheld apparatus comprises a nailer.
